(19) United States
(12) Patent Application Publication
(10) Pub. No.: US 2026/0010056 A1
(43) Pub. Date: Jan. 8, 2026

(54) HOUSING PART FOR THE HOUSING OF A VEHICLE CAMERA, OPTICAL MODULE FOR A VEHICLE CAMERA, VEHICLE CAMERA, VEHICLE COMPRISING AT LEAST ONE VEHICLE CAMERA, AND METHOD FOR PRODUCING A VEHICLE CAMERA

(71) Applicant: VALEO SCHALTER UND SENSOREN GMBH, Bietigheim-Bissingen (DE)

(72) Inventors: Thorsten Cywinski, Bietigheim-Bissingen (DE); Andreas Rapp, Bietigheim-Bissingen (DE); Ellen Marie Heidler, Bietigheim-Bissingen (DE)

(73) Assignee: VALEO SCHALTER UND SENSOREN GMBH, Bietigheim-Bissingen (DE)

(21) Appl. No.: 18/879,985

(22) PCT Filed: Jun. 26, 2023
(86) PCT No.: PCT/EP2023/067259

§ 371 Date: Dec. 30, 2024

(30) Foreign Application Priority Data
Jun. 28, 2022 (DE) 10 2022 116 012.2

(51) Int. Cl. G03B 17/02; G03B 30/00

(52) U.S. Cl. CPC G03B 17/02; G03B 30/00

(57) ABSTRACT

A housing part (18) for a housing (16) for a vehicle camera (14), an optical module for a vehicle camera, a vehicle camera, a vehicle with at least one vehicle camera and a method for producing a vehicle camera are described. The housing part (18) has at least one connecting portion (36) for mechanical connection of the housing part (18) to at least one other part (22) of the vehicle camera (14), at least one projecting projection connecting element (38), which consists of a deformable material at least at one end, being arranged on the at least one connecting portion (36). The at least one projecting projection connecting element (38) consists of a cold-deformable material at least at one end.

### TECHNICAL FIELD

The invention relates to a housing part for a housing for a vehicle camera, which has at least one connecting portion for mechanical connection of the housing part to at least one other part of the vehicle camera, wherein at least one projecting projection connecting element, which consists of a deformable material at least at one end, is arranged on the at least one connecting portion.

The invention further relates to an optical module for a vehicle camera, which has at least one optical module housing part, at least one lens and at least one imager circuit board with at least one imager chip, wherein the at least one lens and the at least one imager circuit board are arranged on the at least one optical module housing part in such a way that the at least one lens is aligned with the at least one imager chip, wherein the at least one optical module housing part has at least one connecting portion for mechanical connection of the at least one optical module housing part to at least one other part of the vehicle camera, wherein at least one projecting projection connecting element, which consists of a deformable material at least at one end, is arranged on the at least one connecting portion.

The invention furthermore relates to a vehicle camera with a housing on which at least one lens is arranged and in which at least one imager chip is arranged, wherein the at least one lens is aligned with the at least one imager chip and the housing has at least two housing parts, which are mechanically connected to one another,
wherein the at least two housing parts each have at least one connecting portion, which are respectively mechanically connected to at least one corresponding connecting portion of the respective other housing part,
wherein the connecting portions are connected by means of at least one projection connecting element, which consists of a deformable material at least at one end, and at least one reception connecting element, through which the at least one projection connecting element is fed, is arranged on at least one of the connecting portions,
wherein the at least one projection connecting element has a deformed grip portion, which engages behind the at least one connecting portion with the at least one reception connecting element, on at least one end which is fed through the at least one reception connecting element.

The invention furthermore relates to a vehicle with at least one vehicle camera.

In addition, the invention relates to a method for producing a vehicle camera, in which at least two housing parts of a housing of the vehicle camera are mechanically connected to one another, wherein one of the housing parts is arranged with a connecting portion on a corresponding connecting portion of the corresponding other housing part, wherein at least one projection connecting element is inserted through at least one reception connecting element of at least one of the connecting portions and at least one free end of the projection connecting element, which is fed through a reception connecting element, is deformed to form a grip portion which engages behind the at least one connecting portion with the at least one reception connecting element.

### PRIOR ART

US 2018/0338071 A1 discloses a camera for a driving assistance system or a vision system or an imaging system for a vehicle, which captures image data representative of images outside the vehicle. The camera comprises a metallic body, for example an extruded aluminum body, with posts which are formed as part of the body, and a method for assembling the camera. The posts are inserted through holes in the printed circuit board when the printed circuit board is fitted into the housing, and the ends of the posts are then flattened (for example by punching or vibration welding or the like) in order to fasten the printed circuit board to the posts. In addition, a rear cover element may be arranged on the rear side of the housing in order to seal the housing. The rear cover element may contain one or more posts which are formed as part of the cover element, and the posts are introduced through holes in a connector structure when the connector structure is arranged on the rear cover element in order to receive electrically conductive terminals (which are electrically connected to circuits on the printed circuit board) therein for electrical connection to a wire harness of the vehicle. The ends of the posts are then flattened in order to fasten the connector structure to the posts. The posts may be flattened by punching or vibration welding, for example after heating the post region in order to improve the malleability of the posts. The posts may be flattened by hot stamping, for example after heating the post in order to improve the malleability of the posts.

It is an object of the invention to configure a housing part, an optical module, a vehicle camera, a vehicle and a method of the type mentioned in the introduction, in which an outlay for manufacturing the vehicle camera, in particular a material outlay and/or a mounting outlay and/or tool outlay, can be reduced.

### DISCLOSURE OF THE INVENTION

The object is achieved according to the invention in the case of the housing part in that the at least one projecting projection connecting element consists of a cold-deformable material at least at one end.

According to the invention, the at least one projection connecting element is cold-deformable. In this way, the at least one projection connecting element can be deformed when it is cold, that is to say without heating it. An outlay for the production of the connection can thus be reduced. On the one hand, an outlay on tools may be reduced in comparison with the hot stamping or vibration welding known from the prior art. The deformation according to the invention may be achieved merely by chiseling or pressing. By heating being avoided, the components can furthermore be protected.

Advantageously, the at least one projection connecting element may consist entirely of a cold-deformable material. In this way, the at least one projection connecting element may be produced with less outlay.

Advantageously, the at least one projecting projection connecting element may consist of a metal alloy or the like. In this way, an on the one hand stable but nevertheless cold-deformable projection connecting element may be produced.

The housing part is intended for a housing of a vehicle camera. With a vehicle camera, images of a monitoring region in the vicinity and/or in the interior of the vehicle may be determined.

Advantageously, the vehicle camera may be an imaging camera. Such vehicle cameras may be used in vehicles to monitor monitoring regions in the vehicle and/or in the vicinity of the vehicle.

Advantageously, the vehicle camera may be a front camera. With a front vehicle camera, a monitoring region in front of a vehicle in the direction of travel may be monitored. The vehicle camera may also be a rearview camera, a side camera, an interior camera or a multifunction vehicle camera.

Advantageously, the vehicle camera may be configured to be arranged on a window, in particular a windshield, of a vehicle. In this way, the vehicle camera may be arranged so that it is protected inside the vehicle. The vehicle camera may in this case be directed into the interior and/or into the vicinity of the vehicle.

Advantageously, the vehicle camera may be employed for motor vehicles. Advantageously, the vehicle camera may be employed for land vehicles, in particular automobiles, trucks, buses, motorcycles, construction or transport machines such as cranes, excavators or the like, aircraft, in particular drones, and/or watercraft. The vehicle camera may also be used for vehicles which can be operated autonomously or at least semiautonomously.

The vehicle camera may advantageously be connected to, or be a part of, at least one electronic control device of a vehicle, in particular a driver assistance system or the like. In this way, at least some of the functions of the vehicle, in particular driving functions, may be operated autonomously or semiautonomously. Information obtained with the vehicle camera may in this case be transmitted to the at least one control device of the vehicle and employed to control functions of the vehicle.

With the vehicle camera, stationary or moving objects, in particular vehicles, persons, animals, plants, obstacles, roadway unevennesses, in particular potholes or rocks, roadway boundaries, traffic signs, free spaces, in particular parking spaces, precipitation or the like, and/or gestures may be captured.

In one advantageous embodiment, the at least one projection connecting element may have a cylindrical, in particular circular-cylindrical shape and/or the at least one projection connecting element may be connected firmly, in particular integrally or as a multipart component or the like, to the at least one connecting portion. A cylindrical shape has the advantage that the projection connecting element can more easily be inserted through a corresponding reception connecting element on the side of the other part of the vehicle camera, and correspondingly deformed behind the latter. The effect of the deformation is that the at least one projection connecting element cannot slip out of the reception connecting element.

Advantageously, the at least one projection connecting element may be connected firmly to the at least one connecting portion. In this way, the at least one projection connecting element can be fastened securely against loss to the at least one connecting portion. Mounting may thus be simplified.

Advantageously, the at least one projection connecting element may be configured integrally with the at least one connecting portion. In this way, the at least one projection connecting element may be manufactured more easily together with the at least one connecting portion.

Advantageously, the at least one connecting portion may be manufactured as an extruded part with the at least one projection connecting element. In this way, the at least one projection connecting element may be manufactured as a cold-deformable part integrally with the at least one connecting portion.

Advantageously, the at least one projection connecting element may be configured as a post, bolt, rib, web or the like. In this way, the at least one projection connecting element may be adapted flexibly to the available expansion space.

In a further advantageous embodiment, the housing part may be an optical module housing part, in particular an optical module housing part for an optical module for a vehicle camera, or a main housing part for a vehicle camera and/or the at least one connecting portion may serve for mechanical connection of the housing part to at least one other housing part of the vehicle camera.

Advantageously, a housing part according to the invention may be an optical module housing part. In this way, the at least one projection connecting element may be arranged on the side of the optical module. The optical module may thus be prefabricated. The prefabricated optical module may be connected to the at least one other part of the vehicle camera, in particular to a main housing part of the vehicle camera. The at least one projection connecting element on the side of the optical module housing part may in this case be inserted through a corresponding reception connecting element on the side of the at least one other part, in particular of the main housing part. The end of the reception connecting element may be cold-deformed behind the reception connecting element to form a grip portion. The grip portion may engage behind the reception connecting element.

Alternatively or in addition, a housing part according to the invention may advantageously be a main housing part for a vehicle camera. The at least one projection connecting element may thus be formed on the main housing part. In this case, the corresponding at least one reception connecting element may be arranged on the side of the other part, in particular of an optical module housing part.

Alternatively or in addition, the at least one connecting portion may advantageously serve for mechanical connection of the housing part to at least one other housing part of the vehicle camera. In this way, two housing parts of the vehicle camera may easily be fixed to one another by means of cold deformation of the corresponding projection connecting elements.

In a further advantageous embodiment, at least one connecting portion may be configured as a flange and/or at least one connecting portion may have at least one positioning element, in particular at least one positioning frame. In this way, the at least one connecting portion of the housing part and the at least one connecting portion of the other part may be connected to one another more easily.

Advantageously, at least one connecting portion may be configured as a flange. The at least one projection connecting element may be arranged more flexibly and more easily accessible on a flange. A flange in the form of a plate-like structural element may be formed as an appendage on a base body of the at least one housing part.

Alternatively or in addition, at least one connecting portion may advantageously have at least one positioning element. With the aid of at least one positioning element, the at least one connecting portion of the housing part and the at least one connecting portion of the other part, in particular of the other housing part, may be positioned more easily with respect to one another.

A corresponding portion of the at least one other part may be enclosed with a positioning frame. The corresponding portion of the at least one other part may thus be precisely positioned and held inside the positioning frame.

Advantageously, a positioning frame may have the same profile on at least one connecting element as a connecting portion, in particular a connecting flange, on at least one part to be connected, in particular a housing part. In this way, the connecting flange may be positioned and held inside the positioning frame.

The object is further achieved according to the invention in the case of an optical module in that the at least one projecting projection connecting element consists of a cold-deformable material at least at one end.

According to the invention, the optical module has at least one connecting portion with a projection connecting element, the end of which is cold-deformable. In this way, the optical module may be fixed on a main housing part of the vehicle camera by the end of the at least one projection connecting element being cold-deformed and a grip portion thus being formed. The grip portion may advantageously engage behind a corresponding reception connecting element of the main housing part. The end of the at least one projection connecting element, which is deformed to form a grip portion, prevents the at least one projection connecting element from being able to slip out of the reception connecting element. The optical module is thus fixed with the cold-deformed end of the at least one projection connecting element on the main housing part.

Advantageously, the optical module may have a housing part according to the invention as an optical module housing part. In this way, the optical module may be connected more easily to the corresponding main housing part of the vehicle camera.

In one advantageous embodiment, the at least one optical module housing part may respectively have on opposite sides at least one connecting portion with at least one projection connecting element and/or the at least one optical module housing part may have at least one connecting portion in the form of a flange and/or at least one imager circuit board may be arranged on a rear side, opposite to at least one lens, of the at least one optical module housing part.

Advantageously, the at least one optical module housing part may respectively have at least one connecting portion on opposite sides. In this way, retaining forces may be introduced more uniformly into the at least one optical module housing part.

Alternatively or in addition, the at least one optical module housing part may advantageously have at least one connecting portion in the form of a flange. In this way, better force introduction into the at least one projection connecting element and/or easier accessibility of the at least one projection connecting element may be achieved.

Alternatively or in addition, at least one imager circuit board may advantageously be arranged on a rear side, opposite to at least one lens, of the at least one optical module housing part. In this way, the at least one imager circuit board may be connected together with the lens and the optical module housing part to further components of the vehicle camera, in particular a main housing part. The optical module may thus be prefabricated more easily. The at least one lens may be aligned with the at least one imager circuit board, in particular the at least one imager chip, during the prefabrication.

The object is furthermore achieved according to the invention in the case of the vehicle camera in that the at least one projection connecting element has a cold-deformed grip portion on at least one end.

According to the invention, the at least one grip portion is cold-deformed. In this way, an outlay for the production of the vehicle camera may be reduced in comparison with deformation by means of introducing heat. Simpler tools, in particular simple stamps, may be employed for cold deformation. Conversely, tools for heating the components are required for hot deformation. Further, cold deformation protects the components better since they do not need to be heated.

Advantageously, at least one of the housing parts of the vehicle camera may be a housing part according to the invention, in particular an optical module housing part and/or a main housing part. In this way, an outlay for manufacturing the vehicle camera, in particular a material outlay and a mounting outlay, may be reduced. Further, a tool outlay may thus also be reduced.

Advantageously, at least one projecting projection connecting element may be arranged at least one of the connecting portions of one of the housing parts. In this way, the at least one projection connecting element may be held securely against loss on the at least one connecting portion.

Alternatively or in addition, at least one projection connecting element may advantageously be configured as a separate component. The at least two connecting portions connected to one another may each have a corresponding reception connecting element. The separate at least one projection connecting element may be fed through both reception connecting elements. The at least one projection connecting element may respectively have a cold-deformed grip portion at both ends.

In one advantageous embodiment, the vehicle camera may have at least one optical module which has at least one optical module housing part, at least one lens and at least one imager circuit board with at least one imager chip, and/or the vehicle camera may comprise at least one main housing part, which has a lens feed-through opening for at least one lens and/or at least one lens reception socket of an optical module housing part of the vehicle camera.

Advantageously, the vehicle may have at least one lens module. An optical module may be prefabricated. The at least one lens and the at least one imager chip may in this case be aligned relative to one another. The prefabricated optical module may be connected more easily to further parts of the vehicle camera, in particular the main housing part.

Advantageously, the vehicle camera may have at least one optical module according to the invention. In this way, the vehicle camera may be manufactured with less outlay.

Alternatively or in addition, the vehicle camera may advantageously have at least one main housing part with at least one lens feed-through opening. At least one lens of the vehicle camera may be fed through the lens feed-through opening.

Alternatively or in addition, the lens feed-through opening may advantageously be configured so that a lens reception socket of the optical module housing part can additionally be fed through. In this way, the optical module housing part, in particular the optical module, may be arranged on an inner side of the main housing part, the lens being fed out through the lens feed-through opening.

In another advantageous embodiment,
at least one projection connecting element may be arranged with a side facing away from the free end on a connecting portion of a main housing part of the housing and the at least one corresponding reception connecting element may be arranged on a connecting portion of an optical module housing part of the housing
and/or
at least one projection connecting element may be arranged with a side facing away from the free end on a connecting portion of an optical module housing part of the housing and at least one corresponding reception connecting element may be arranged on a connecting portion of a main housing part of the housing
and/or
at least one projection connecting element may be a separate component, both ends of which respectively have a cold-deformed grip portion.

Advantageously, at least one projection connecting element may be fastened to a connecting portion of a main housing part. In this way, the projection connecting element is arranged securely against loss on the main housing part and may be connected together with the latter to the optical module housing part.

Alternatively or in addition, at least one projection connecting element may advantageously be arranged on a connecting portion of an optical module housing part. In this way, the at least one projection connecting element may be prefabricated together with the optical module housing part and then connected to the main housing part.

Alternatively or in addition, at least one housing part may advantageously have both at least one projection connecting element and at least one reception connecting element. In this way, the housing parts may be configured more flexibly in respect of their shape and accessibility.

Alternatively or in addition, at least one projection connecting element may advantageously be formed as a separate component. The at least one projection connecting element may thus be connected flexibly to the corresponding connecting portions. In particular, the connecting portion of the main housing part and the connecting portion of the optical module housing part may each have a reception connecting element. The projection connecting element may thus be inserted through both reception connecting elements and then respectively cold-deformed at opposite ends. A cold-deformed grip portion is thus respectively created at the opposite ends of the projection connecting element. A separate projection connecting element may be formed from a different material than the housing parts with the connecting portions. Materials that are not themselves cold-deformable may thus be employed for the connecting portions.

In addition, the object is achieved according to the invention in the case of the vehicle in that the vehicle has at least one vehicle camera according to the invention.

With a vehicle camera, at least one monitoring region in the vicinity of the vehicle and/or in the interior of the vehicle may be monitored, particularly in respect of objects.

Advantageously, the vehicle may have at least one driving assistance system. With the driver assistance system, the vehicle may be operated autonomously or at least semiautonomously.

Advantageously, at least one vehicle camera may be functionally connected to at least one driver assistance system of the vehicle. In this way, information relating to the at least one monitoring region, which can be determined with the at least one vehicle camera, may be transmitted to the at least one driver assistance system. With the at least one driver assistance system, the vehicle may be operated autonomously or at least semiautonomously while taking into account the information relating to the at least one monitoring region.

Furthermore, the object is achieved according to the invention in the case of the method in that the at least one free end of the at least one projection connecting element is cold-deformed to form a grip portion.

According to the invention, the at least one free end of the projection connecting element is cold-deformed to form a grip portion after insertion through the at least one reception connecting element. No action of heat is required for the cold deformation. The components are thus not stressed by the action of heat. In addition, the outlay on required tools is less in the case of cold deformation than in the case of hot deformation.

Advantageously, the cold deformation may take place with the aid of a punch which is pressed onto the free end of the at least one projection connecting element. A punch may be manufactured and used simply.

Advantageously, at least one projecting projection connecting element, which is fastened to one of the connecting portions, may be inserted through at least one reception connecting element of the respective other connecting portion. In this way, the at least one projection connecting element may be arranged securely against loss on one side on the corresponding connecting portion. The projection connecting element may then be inserted through the corresponding reception connecting element.

Alternatively or in addition, at least one projection connecting element may advantageously be inserted through respective reception connecting elements in both of the connecting portions. The ends of the at least one projection connecting element may then be cold-deformed to form a respective grip portion on both sides. In this way, separate projection connecting elements may be employed. A corresponding reception connecting element may respectively be provided in the two connecting portions.

In one advantageous configuration of the method, an optical module housing part may be employed as at least one of the at least two housing parts and connected to at least one lens and at least one imager circuit board to form an optical module, then the optical module may be connected to a main housing part, which may be employed as the other of the at least two housing parts. In this way, an optical module may be prefabricated with the optical module housing part, the lens and the imager circuit board. The prefabricated optical module may be connected to the main housing part in the manner according to the invention.

Advantageously, the at least one imager circuit board may have at least one imager chip. With an imager chip, light rays can be converted into electrical signals. The electrical signals may be processed in an electronic evaluation instrument. With an imager chip, a two-dimensional image of a monitoring region captured with the vehicle camera may be generated.

Advantageously, the at least one lens may be aligned with the at least one imager chip. In this way, light rays captured with the at least one lens may be imaged onto the at least one imager chip.

Advantageously, the at least one lens may be aligned with the at least one imager chip before the lens module housing part is connected to the main housing part. In this way, the lens module may be fully prefabricated. The final mounting of the vehicle camera may thus be simplified.

In a further advantageous configuration of the method, the optical module may be arranged with the lens forward from an inner side of the main housing part on the main housing part so that at least the lens protrudes through a lens feed-through opening of the main housing part. In this way, a large part of the optical module may be arranged compactly inside the main housing part.

Advantageously, at least one projection connecting element, which is arranged on the inner side of the main housing part, may be inserted through at least one corresponding reception connecting element on the side of the optical module housing part. In this way, the at least one projection connecting element may be arranged inside the housing. In this way, the at least one projection connecting element may be protected from the environment. Further, elevations on the outer side of the housing of the vehicle camera due to the grip portion are thus avoided.

Advantageously, the at least two housing parts may be positioned relative to one another with the aid of at least one positioning element, in particular a positioning frame. In this way, the components may be assembled more precisely and more easily.

In other regards, the features and advantages indicated in connection with the housing part according to the invention, the optical module according to the invention, the vehicle camera according to the invention, the vehicle according to the invention and the method according to the invention, and their respective advantageous configurations, apply correspondingly to one another, and vice versa. The individual features and advantages may of course be combined with one another, in which case further advantageous effects extending beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. A person skilled in the art will expediently also consider the features disclosed in combination in the drawing, the description and the claims individually and combine them to form further suitable combinations. In the drawing, schematically,

FIG. 1 shows a front view of a vehicle with a driver assistance system and a vehicle camera;

FIG. 2 shows an exploded representation of a vehicle camera without a housing lower part according to a first exemplary embodiment of the vehicle of FIG. 1;

FIG. 3 shows an isometric representation of the vehicle camera of FIG. 2 with a view of the open rear side without a housing lower part;

FIG. 4 shows a section of the vehicle camera of FIG. 3 along the section plane Ill therein, here with the housing lower part;

FIG. 5 shows an isometric representation of an optical module of the vehicle camera of FIGS. 2 to 4;

FIG. 6 shows an exploded representation of a vehicle camera without a housing lower part according to a second exemplary embodiment of the vehicle of FIG. 1;

FIG. 7 shows an isometric representation of the vehicle camera of FIG. 2 with a view of the front side;

FIG. 8 shows an isometric representation of an optical module of the vehicle camera of FIGS. 6 and 7;

FIG. 9 shows a section of the vehicle camera of FIG. 7 along the section plane VIII therein;

FIG. 10 shows an exploded representation of a vehicle camera without a housing lower part according to a third exemplary embodiment of the vehicle of FIG. 1.

In the figures, identical components are provided with the same reference signs.

### EMBODIMENT(S) OF THE INVENTION

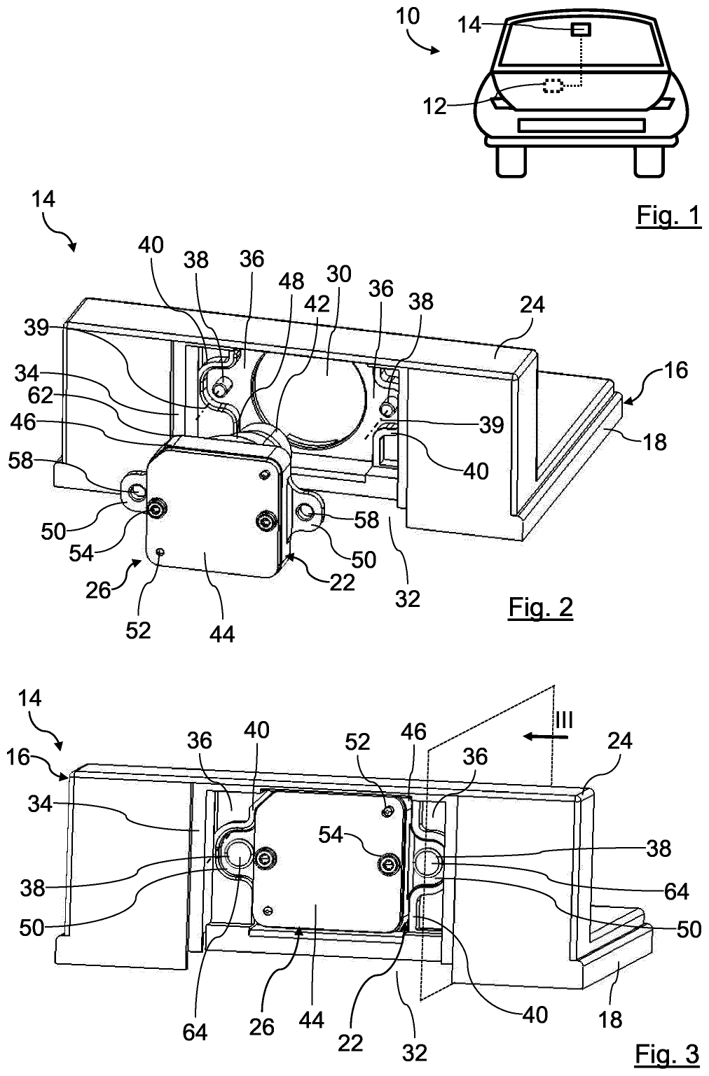

FIG. 1 shows the front view of a vehicle 10 in the form of an automobile. The vehicle 10 comprises a driver assistance system 12 and a vehicle camera 14.

The vehicle camera 14 is functionally connected to the driver assistance system 12. Information which is obtained with the vehicle camera 14 may thus be transmitted to the driver assistance system 12. With the driver assistance system 12, the vehicle 10 may be operated autonomously or semiautonomously.

The vehicle camera 14 is configured for example as a front camera, for example a windshield camera. The vehicle camera 14 is located at the top on the inner side of the windshield of the vehicle 10 and is directed into a monitoring region in front of the vehicle 10 in the direction of travel. The vehicle camera 14 may also be arranged elsewhere in the vehicle 10 and be aligned differently. A plurality of vehicle cameras 14 may also be provided on or in the vehicle 10. A vehicle camera 14 may also be directed into an interior of the vehicle 10.

The vehicle camera 14 is, for example, an imaging camera. With the vehicle camera 14, the monitoring region can be captured with position resolution.

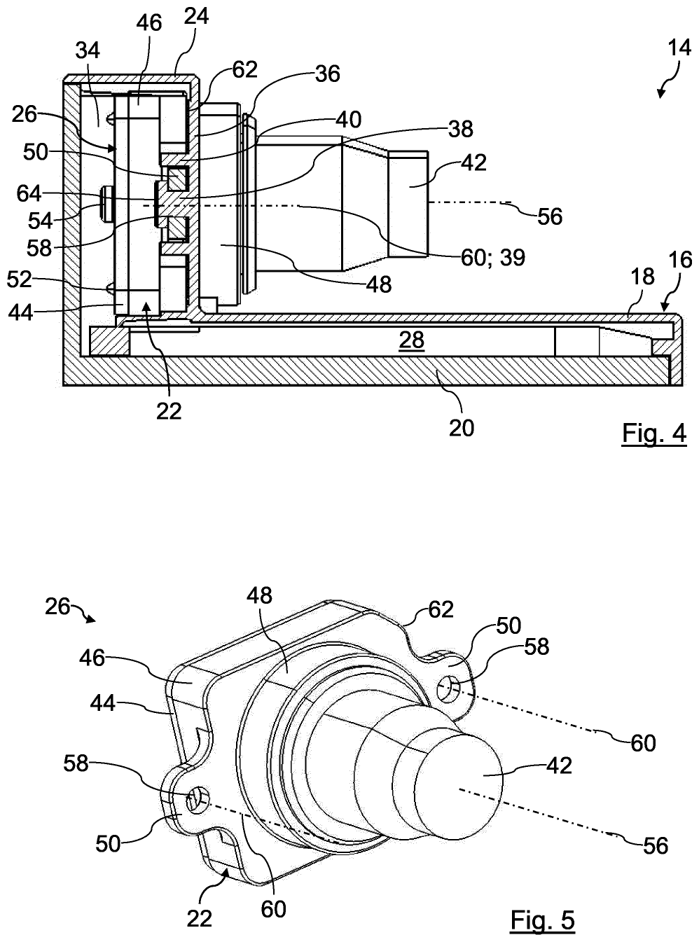

FIG. 2 represents the vehicle camera 14 according to a first exemplary embodiment of the vehicle 10 of FIG. 1 in an exploded representation without a housing lower part 20, which is shown in FIG. 4. FIG. 3 shows an isometric representation of the vehicle camera 14 of FIG. 2. FIG. 4 shows a section of the vehicle camera 14 of FIG. 3 along the section plane III therein—here with the housing lower part 20.

The vehicle camera 14 has a housing 16. The housing 16 comprises a main housing part 18, the housing lower part 20 and an optical module housing part 22.

The main housing part 18 has a stepped portion 24. An optical module 26 is arranged in the stepped portion 24.

On the lower side, the main housing part 18 has a lower installation opening which is closed when the vehicle camera 14 is finally mounted with the housing lower part 20. A main printed circuit board (not shown in the figures for the sake of better clarity) can be installed through the lower installation opening into a housing interior 28 of the housing 16.

A lens feed-through opening 30 is provided in a front wall on the front side of the stepped portion 24 of the main housing part 18. The lens feed-through opening 30 is a round hole.

The rear side of the stepped portion 24 has a rear installation opening 32. The rear installation opening 32 lies opposite the lens feed-through opening 30. The optical module 26 can be fitted into the main housing part 18 through the rear installation opening 32. When the vehicle camera 14 is fully mounted, the rear installation opening 32 is closed with the housing lower part 20, as shown in FIG. 4.

A module reception space 34 is formed between the front side of the stepped portion 24 and the rear side of the housing lower part 20. The majority of the optical module 26 is arranged in the module reception space 34.

Two main connecting portions 36 are formed in the front wall of the stepped portion 24. The main connecting portions 36 are located on opposite sides of the lens feed-through opening 30. The main connecting portions 36 are each planar wall portions of the front wall.

On each of the main connecting portions 36, a projection connecting element 38 is arranged projecting from the corresponding main connecting portion 36. The projection connecting elements 38 each have the shape of a circular-cylindrical post before the vehicle camera 14 is assembled, as shown in FIG. 2. The projection connecting elements 38 extend on the inner side of the corresponding main connecting portion 36, which faces toward the module reception space 34, in the direction of the installation opening 32. Imaginary axes 39 of the projection connecting elements 38 run parallel to one another.

Further, a positioning element in the form of a positioning frame 40 is arranged in each of the main connecting portions 36. The positioning frames 40 are located on the inner side of the respective main connecting portions 36, which faces toward the module reception space 34. The positioning frames 40 are each configured as a web. The positioning frames 40 are raised from the main connecting portion 36 with a constant width and equal height in the direction of the installation opening 32. As viewed from the installation opening 32, the positioning frames 40 each have approximately an Q-shaped profile. The positioning frames 40 each run around the projection connecting element 38 of the respective main connecting portion 36.

The projection connecting elements 38 and the positioning frames 40 are respectively connected integrally to the main connecting portions 36. The projection connecting elements 38 consist of a cold-deformable material, for example a metal alloy.

The optical module 26 is shown in detail in FIG. 5. The optical module 26 has the optical module housing part 22, a lens 42 and an imager circuit board 44.

The optical module housing part 22 comprises a module base body 46, a lens reception socket 48 and two module connecting portions 50.

The module base body 46 approximately has the shape of a hollow cuboid, which has an opening on its rear side. The opening is closed with the imager circuit board 44. The imager circuit board 44 is positioned by means of two positioning posts 52 and is fixed to the module base body 46 by means of two screws 54.

The lens reception socket 48 is arranged on the opposite side of the module base body 46 from the imager circuit board 44. The lens reception socket 48 is connected integrally to the module base body 46. The lens reception socket 48 approximately has the shape of a hollow circular cylinder. The lens 42 is inserted in the lens reception socket 48 and is fixed thereto. The lens reception socket 48 is coaxial with a lens axis 56.

An imager chip (which is concealed in FIG. 4) is arranged on the imager circuit board 44. The imager chip is located on the side of the imager circuit board 44 which faces toward the lens reception socket 48 and the lens 42. The lens 42 is aligned with the imager chip. With the imager chip, light rays can be converted into electrical signals.

The module connecting portions 50 are each formed as a flange in the form of plate-like structural parts as appendages on the module base body 46. The module connecting portions 50 each extend away from the module base body 46.

The module connecting portions 50 are arranged on opposite sides of the module base body 46. The module connecting portions 50 are located on opposite sides in relation to a lens axis 56 of the lens 42. The module connecting portions 50 are each formed integrally with the module base body 46.

The front faces of the module base body 46 and of the module connecting portions 50, which face toward the lens reception socket 48, extend in a common plane. The front faces form a planar bearing face for the main connecting portions 36 of the main housing part 18.

The thicknesses of the module connecting portions 50 are less than the lengths of the projection connecting elements 38 of the main housing part 18.

Each module connecting portion 50 has a reception connecting element 58. The reception connecting elements 48 are formed as through-holes in the respective module connecting portion 50. The cross section of the reception connecting elements 48 corresponds to the cross section of the projection connecting elements 38. In the exemplary embodiment shown, the reception connecting elements 48 each have a round cross section.

Imaginary axes 60 of the reception connecting elements 58 extend parallel to one another. Further, the axes 60 extend parallel to the lens axis 56.

A profile of a front edge 62 of the optical module housing part 22 on the side facing toward the lens reception socket 48 corresponds to the profile of the inner side of the positioning frames 40 of the main housing part 18. The positions of the reception connecting elements 58 relative to the front edge 62 correspond to the positions of the projection connecting elements 38 of the main housing part 18 relative to the positioning frames 40.

A spacing of the axes 60 of the reception connecting elements 58 of the optical module housing part 22 corresponds to a spacing of the axes 39 of the projection connecting elements 38 of the main housing part 18.

The diameter of the reception connecting elements 58 is the same. The outer diameter of the reception connecting elements 38 is likewise the same before the optical module 26 is mounted on the main housing part 18. The diameter of the reception connecting elements 58 is somewhat greater than the diameter of the projection connecting elements 38 before the optical module 26 is mounted on the main housing part 18.

Both the reception connecting elements 58 and the projection connecting elements 38 and the positioning frames 40 are symmetrical with respect to an imaginary midplane with the lens axis 56.

In order to produce the vehicle camera 14, the optical module 26 is prefabricated with the optical module housing part 22, the imager circuit board 44 and the lens 42.

The prefabricated optical module 26 is brought with the lens 42 forward through the installation opening 32 of the stepped portion 24 of the main housing part 18 in the module reception space 34. The lens 42 and the lens reception socket 48 are in this case fed into the lens feed-through 30.

The optical module 26 is aligned so that the module connecting portions 50 are arranged inside the positioning frames 40 of the main housing part 18 and the projection connecting elements 38 of the main housing part 18 are arranged in the respective reception connecting elements 58 of the optical module 26.

The optical module 26 is pushed into the module reception space 34 until the module connecting portions 50 bear on the respective main connecting portions 36. In this position of the optical module 26, the ends of the projection connecting elements 38 protrude out of the reception connecting elements 58. The free ends of the projection connecting elements 38 are then cold-deformed to form a respective grip portion 64. For this purpose, for example, a stamp or the like may be used. This mounting phase is shown in FIGS. 3 and 4.

The grip portions 64 each have an edge which is circumferentially continuous in relation to the axis 60 and which engages behind the respective reception connecting element 58. The outer diameter of the grip portions 64 is greater than the inner diameter of the reception connecting elements 58. In this way, the projection connecting elements 38 are retained in the respective reception connecting elements 58.

With the grip portions 64, the optical module housing part 22 and therefore the entire optical module 26 are held on the inner side of the stepped portion 24 of the main housing part 18.

Before or after the optical module 26 is installed in the module reception space 34, the main circuit board is arranged in the housing interior 28. The main circuit board is not shown in the figures for the sake of better clarity. The imager circuit board 44 is, for example, connected to the main circuit by a flexible cable. The flexible cable is likewise not shown for the sake of better clarity.

Finally, the housing lower part 20 is fastened to the main housing part 18. The installation opening 32 in the stepped portion 24 and the lower installation opening of the main housing part 18 are thus closed. The cold-deformed grip portions 64 are not visible from the outside and are protected from the environment in the module reception space 34.

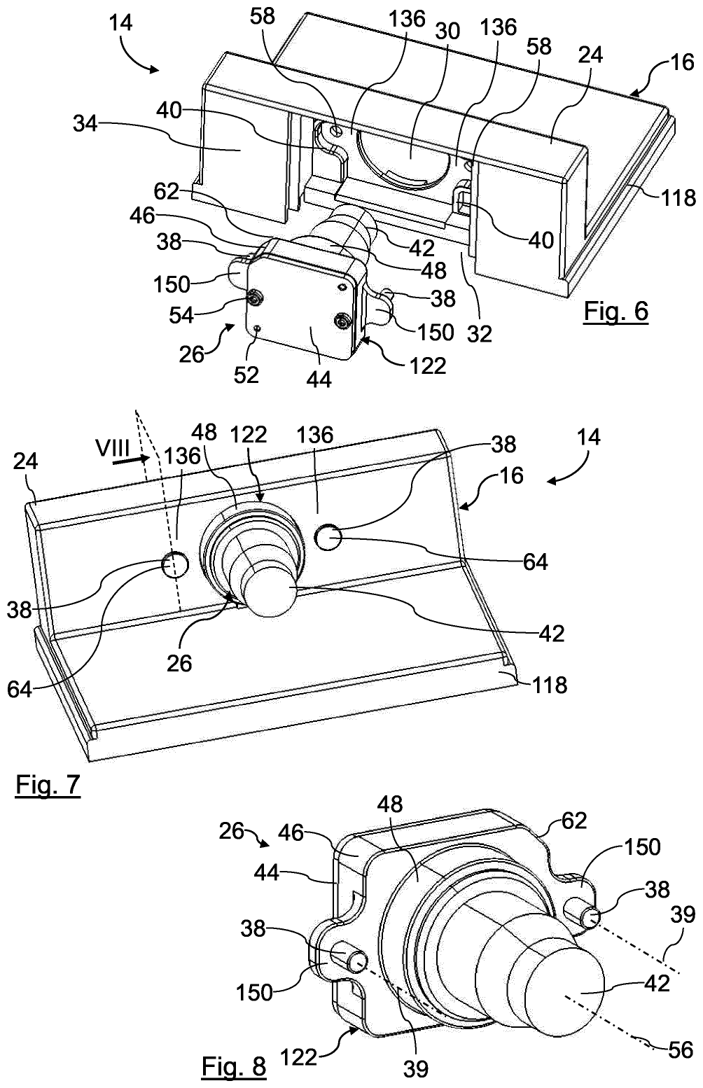

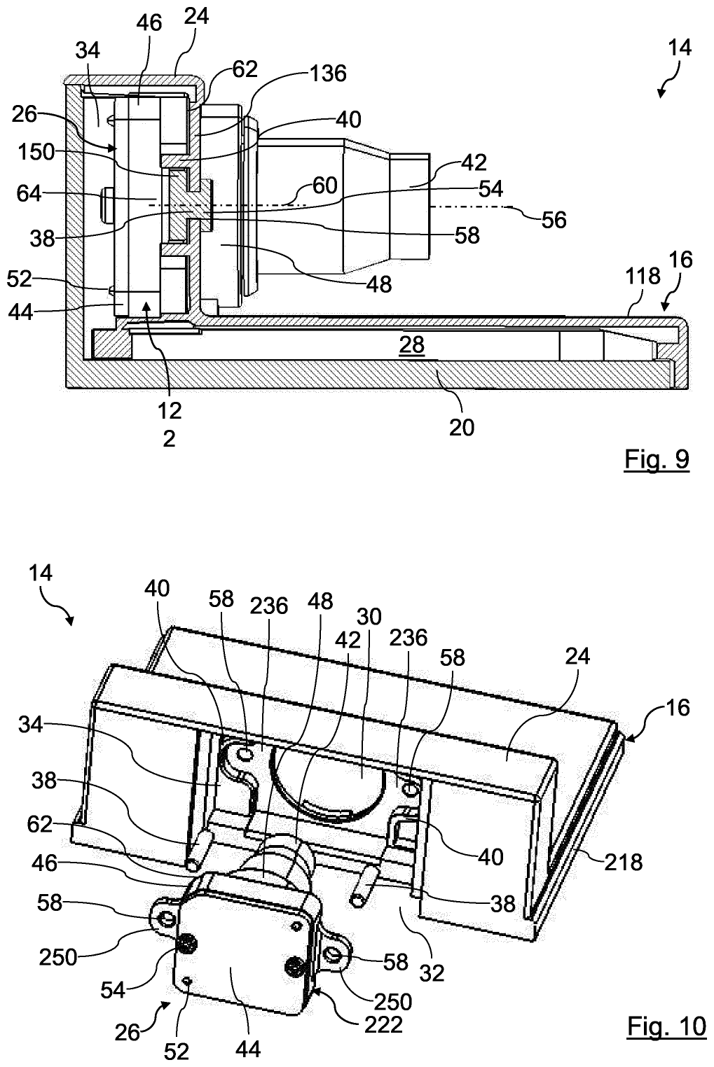

FIGS. 6 to 9 show a vehicle camera 14 according to a second exemplary embodiment. The elements which are similar to those of the first exemplary embodiment of FIGS. 2 to 5 are provided with the same reference signs. The second exemplary embodiment differs from the first exemplary embodiment in that the projection connecting elements 38 are arranged on the side of module connecting portions 150 of an optical module housing part 122. The corresponding reception connecting elements 58 are located in main connecting portions 136 in the front wall of the stepped portion 24 of the main housing part 118 on opposite sides of the lens feed-through opening 30.

When the vehicle camera 14 has been assembled, the grip portions 64 are correspondingly located on the outer side of the stepped portion 24 of the main housing part 118 on opposite sides next to the lens reception socket 48.

FIG. 10 shows a vehicle camera 14 according to a third exemplary embodiment. The elements which are similar to those of the first exemplary embodiment of FIGS. 2 to 5 are provided with the same reference signs. The third exemplary embodiment differs from the first exemplary embodiment in that the projection connecting elements 38 are formed as separate components.

The projection connecting elements 38 each have the shape of a circular-cylindrical post before the vehicle camera 14 is assembled.

Corresponding reception connecting elements 58 in the form of through-holes are arranged both in module connecting portions 250 of an optical module housing part 222 and in main connecting portions 236 of a main housing part 218.

The lengths of the projection connecting elements 38 are greater than the spacings between the outer side of the front wall of the stepped portion 24 and the rear side of the module connecting portions 250 when the optical module 26 is inserted. The two ends of the respective projection connecting elements 38 protrude both from the corresponding reception connecting elements 58 of the main housing part 218 and from the corresponding reception connecting elements 58 of the optical module housing part 222.

During the production of the vehicle camera 14, the projection connecting elements 38 are cold-deformed at both ends so that a grip portion 64 is respectively formed at both ends.

1. A housing part for a housing for a vehicle camera, the housing part comprises:
at least one connecting portion for mechanical connection of the housing part to at least one other part of the vehicle camera; and
at least one projecting projection connecting element, which consists of a deformable material at least at one end, is arranged on the at least one connecting portion,
wherein the at least one projecting projection connecting element consists of a cold-deformable material at least at one end.

2. The housing part as claimed in claim 1, wherein the at least one projection connecting element has a cylindrical shape, and/or the at least one projection connecting element is connected firmly, to the at least one connecting portion.

3. The housing part as claimed in claim 1, wherein the housing part is an optical module housing part for an optical module for a vehicle camera, or a main housing part for a vehicle camera and/or the at least one connecting portion serves for mechanical connection of the housing part to at least one other housing part of the vehicle camera.

4. The housing part as claimed in claim 1, wherein at least one connecting portion is configured as a flange and/or at least one connecting portion has at least one positioning element.

5. An optical module for a vehicle camera, the optical module comprises:
at least one optical module housing part;
at least one lens;
at least one imager circuit board with at least one imager chip,
wherein the at least one lens and the at least one imager circuit board are arranged on the at least one optical module housing part in such a way that the at least one lens is aligned with the at least one imager chip,
wherein the at least one optical module housing part has at least one connecting portion for mechanical connection of the at least one optical module housing part to at least one other part of the vehicle camera; and
at least one projecting projection connecting element, which consists of a deformable material at least at one end, arranged on the at least one connecting portion,
wherein the at least one projecting projection connecting element consists of a cold-deformable material at least at one end.

6. The optical module as claimed in claim 5, wherein the at least one optical module housing part respectively has on opposite sides at least one connecting portion with at least one projection connecting element and/or the at least one optical module housing part has at least one connecting portion in a form of a flange and/or at least one imager circuit board is arranged on a rear side, opposite to at least one lens, of the at least one optical module housing part.

7. A vehicle camera comprises a housing on which at least one lens is arranged and in which at least one imager chip is arranged,
wherein the at least one lens is aligned with the at least one imager chip and the housing has at least two housing parts, which are mechanically connected to one another,
wherein the at least two housing parts each have at least one connecting portion, which are respectively mechanically connected to at least one corresponding connecting portion of the respective other housing part,
wherein the connecting portions are connected by at least one projection connecting element, which consists of a deformable material at least at one end, and at least one reception connecting element, through which the at least one projection connecting element is fed, is arranged on at least one of the connecting portions,
wherein the at least one projection connecting element has a deformed grip portion, which engages behind the at least one connecting portion with the at least one reception connecting element, on at least one end which is fed through the at least one reception connecting element,
wherein the at least one projecting projection connecting element has a cold-deformed grip portion on at least one end.

8. The vehicle camera as claimed in claim 7, further comprising:
at least one optical module, which has at least one optical module housing part;
at least one lens; and
at least one imager circuit board with at least one imager chip, and/or the vehicle camera comprises:
at least one main housing part, which has a lens feed-through opening for at least one lens; and/or
at least one lens reception socket of an optical module housing part of the vehicle camera.

9. The vehicle camera as claimed in claim 7,
wherein the at least one projection connecting element is arranged with a side facing away from a free end on a connecting portion of a main housing part of the housing,
wherein the at least one corresponding reception connecting element is arranged on a connecting portion of an optical module housing part of the housing, and/or
wherein the at least one projection connecting element is arranged with a side facing away from the free end on a connecting portion of an optical module housing part of the housing,
wherein at least one corresponding reception connecting element is arranged on a connecting portion of a main housing part of the housing, and/or
wherein the at least one projection connecting element is a separate component, both ends of which respectively have a cold-deformed grip portion.

10. A vehicle with at least one vehicle camera, the vehicle has at least one vehicle camera as claimed in claim 7.

11. A method for producing a vehicle camera,
connecting mechanically at least two housing parts of a housing of the vehicle camera to one another;
arranging one of the housing parts with a connecting portion on a corresponding connecting portion of the corresponding other housing part;
inserting at least one projection connecting element through at least one reception connecting element of at least one of the connecting portions;
deforming at least one free end of the projection connecting element, which is fed through a reception connecting element, to form a grip portion which engages behind the at least one connecting portion with the at least one reception connecting element; and
cold-deforming the at least one free end of the at least one projection connecting element to form a grip portion.

12. The method as claimed in claim 11, further comprising:
employing an optical module housing part as at least one of the at least two housing parts;
connecting the optical module housing part to at least one lens and at least one imager circuit board to form an optical module; and
connecting the optical module to a main housing part, which is employed as the other of the at least two housing parts.

13. The method as claimed in claim 12, further comprising arranging the optical module with the lens forward from an inner side of the main housing part on the main housing part so that at least the lens protrudes through a lens feed-through of the main housing part.
